(19) United States
(12) Patent Application Publication
(10) Pub. No.: US 2026/0030299 A1
(43) Pub. Date: Jan. 29, 2026

(54) FRAMEWORK FOR QUERY GENERATION IN AN ARTIFICIAL INTELLIGENCE ENVIRONMENT

(71) Applicant: Hartford Fire Insurance Company, Hartford, CT (US)

(72) Inventors: Srinivas Kamini, Sun Prairie, WI (US); Dean M. Mazzotta, North Grandby, CT (US)

(21) Appl. No.: 18/785,609

(22) Filed: Jul. 26, 2024

(51) Int. Cl. G06F 16/9032; G06N 3/0475

(52) U.S. Cl. CPC G06F 16/90332; G06N 3/0475

(57) ABSTRACT

According to some embodiments, systems and methods are provided including a memory storing program code: and one or more processing units to execute the program code to cause the system to: receive a natural language query; generate a Structured Query Language (SQL) query based on the received natural language query; invoke an Application Programming Interface (API) call with the SQL query; receive a response to the SQL query from a data source; generate a natural language response; and transmit the natural language response to an entity. Numerous other aspects are provided.

### BACKGROUND

Today's organizations collect and store large sets of data at an ever-increasing rate. For those organizations that offer products and/or services associated with customer accounts, the organizations rely on humans understanding and using the data in customer interactions via, for example, call centers. The customers may also access the data via an internet-based system or via an Interactive Voice Response (IVR) system—an automated phone system technology that allows incoming callers (e.g., customers) to access information via a voice response system of pre-recorded messages of menu options selected via touch tone keypad without having to speak to a human.

The use of call centers may be advantageous for those customers wishing to speak with a human. However, there are increased costs with human customer service staffing, and there may be long wait times for customers as there is necessarily a limited amount of human customer service staff.

The use of internet-based systems and IVR systems can provide customers with requested information and perform routine actions without having to maintain a large human customer service staff, as in the call centers. However, the internet-based systems and IVR systems are often rigid as they are limited by scripted questions and responses. These systems also require manual configuration and development, making them difficult or too expensive to adapt to changing needs.

It would therefore be desirable to provide improved systems and methods to accurately and/or automatically retrieve desired information from stored data. Moreover, results should be easy to access, understand, interpret, update, etc.

### SUMMARY OF THE INVENTION

According to some embodiments, systems, methods, apparatus, computer program code and means are provided to accurately and/or automatically retrieve desired information, the retrieved information provided in a way that provides fast and useful results and that allows for flexibility and effectiveness when implementing those results.

Some embodiments are directed to a system comprising: a memory storing program code: and one or more processing units to execute the program code to cause the system to: receive a natural language query; generate a Structured Query Language (SQL) query based on the received natural language query; invoke an Application Programming Interface (API) call with the SQL query; receive a response to the SQL query from a data source; generate a natural language response; and transmit the natural language response to an entity.

Some embodiments comprise: receiving a natural language query; extracting one or more intents from the natural language query; generating a Structured Query Language (SQL) query based on the extracted intents; invoking an Application Programming Interface (API) call with the SQL query; receiving a response to the SQL query from a data source; generating a natural language response; and transmitting the natural language response to an entity.

In some embodiments, a communication device associated with a back-end application computer server exchanges information with remote devices in connection with an interactive graphical user interface. The information may be exchanged, for example, via public and/or proprietary communication networks.

A technical effect of some embodiments of the invention is an improved and computerized way to accurately and/or automatically retrieve information from a data store in a way that provides fast and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a SQL generation framework in accordance with some embodiments of the present invention.

FIG. 2 is a more detailed block diagram of the SQL generation framework of FIG. 1 in accordance with some embodiments of the present invention.

FIG. 3A illustrates a SQL generation method according to some embodiments of the present invention.

FIG. 3B illustrates a continuation of the SQL generation method of FIG. 3B according to some embodiments of the present invention.

FIG. 4 is a user interface for creating a natural language query according to some embodiments of the present invention.

FIG. 5 is a user interface presenting an answer to a user query according to some embodiments of the present invention.

FIG. 6 illustrates a block diagram of multiple data dictionaries and associated applications according to some embodiments of the present invention.

FIG. 7 illustrates a block diagram of an apparatus according to some embodiments of the present invention.

FIG. 8 is a non-exhaustive example of a data store according to some embodiments of the present invention.

FIG. 9 is another non-exhaustive example of a data store according to some embodiments of the present invention.

FIG. 10 illustrates a tablet computer display according to some embodiments of the present invention.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

The present invention provides significant technical improvements to facilitate data efficiency and usefulness associated with a SQL generation framework. The present invention is directed to more than merely a computer implementation of a routine or conventional activity previously known in the industry as it provides a specific advancement in the area of electronic record analysis by providing improvements in the operation of a computer system that facilitates the generation of SQL queries and retrieval of data from data stores. The present invention provides improvement beyond a mere generic computer implementation as it involves the novel ordered combination of system elements and processes to provide improvements in the speed and ease of such data retrieval. Some embodiments of the present invention are directed to a system adapted to automatically generate a Structured Query Language (SQL) query from a natural language request, retrieve data from a data source using the SQL query and return a response to a user. Some embodiments of the present invention are directed to aggregate data from multiple data sources, to automatically optimize equipment information to reduce unnecessary messages or communications, etc. Moreover, communication links and messages may be automatically established, aggregated, formatted, exchanged, etc. to improve network performance (e.g., by reducing an amount of network messaging bandwidth and/or storage required to implement such data retrieval, support technological updates, etc.).

As described above, increasingly organizations may use internet-based systems and IVR systems to retrieve data from data sources to provide customers with requested information and perform routine actions without human interaction. A data source may implement an Application Programming Interface (API) which is a software interface that provides external applications with access to stored data. It is noted that utilizing APIs to access information in a data store adds a layer of protection to the database as compared to directly accessing the database because APIs allow for controls to be put into place that ensure that only valid users have access to the database and that only valid requests can modify the data within the database. An API call is executed to provide an answer to a query. A query can be at least one of a request for data results from a database and a request for action on the data. The query can give an answer to a question, perform calculations, combine data from different tables, add, change, or delete data from a database. The API may include a plurality of versions of a business object that can be stored and manipulated by applications. A business object is a semantic entity that represents the smallest unit in a scenario, and represents real objects such as orders, customers, articles, etc. The business object may define data structures and logic.

An API specification (e.g., “API contract”) is a structured file providing the definition and structure of the API. The API specification describes function calls provided by the API, including their parameters, example parameter values, and example usages. The data of a data source may be directly accessed via these API function calls, after determining which functions to use and how to use them in order to obtain the desired result. These configuration and development considerations make the use of APIs a very manual and expensive process. Further, each time a business object is added to a data source, a new query is generated or a new data source is provided, an API needs to be updated and/or created to access the data. Additionally, with respect to the generation of new queries, in a case conventional systems cannot answer the query (e.g., there's no API for the query), the query is routed to a human, which may have the above-described drawbacks.

To address these problems, the SQL generation framework provided by embodiments automatically provides a response to natural language queries by converting the query into a Structured Query Language (SQL) request using a trained large language model. The SQL generation framework provides the query response by building no contract-based APIs and instead by providing a query response API using the generated SQL request. The query response API fetches particular data in response to unique queries (e.g., those generated by the SQL generation framework that define the parameters that specify query text, pagination details, metadata filters, and other search settings). Embodiments also provide for automatically addressing inquiries for incoming Voice interactions or chats. The metrics provided by inputs and a servicing summary for those inquiries may be used to continuously train a text generation model pursuant to embodiments. In one or more embodiments, the text generation model is a large language model (LLM). The collected metrics are also used to build pro-active communications, reducing inquiries over time.

Briefly, a natural language query is received from a user, and instructions to generate a search query are transmitted to a process inquiry system along with a user prompt which includes or is based on the natural language query. The process inquiry system uses a text generation model (e.g., an LLM) to identify intents and to convert the natural language query to a structure query language query. The process inquiry system then invokes an inquiry API (e.g., query response API) to run against the appropriate data source and retrieve the appropriate response. The inquiry API retrieves the information and provides a structured result set to the process inquiry system. The process inquiry system then provides the intents and the result set to a GenAI tool to build the response, and then transmits the response to the user.

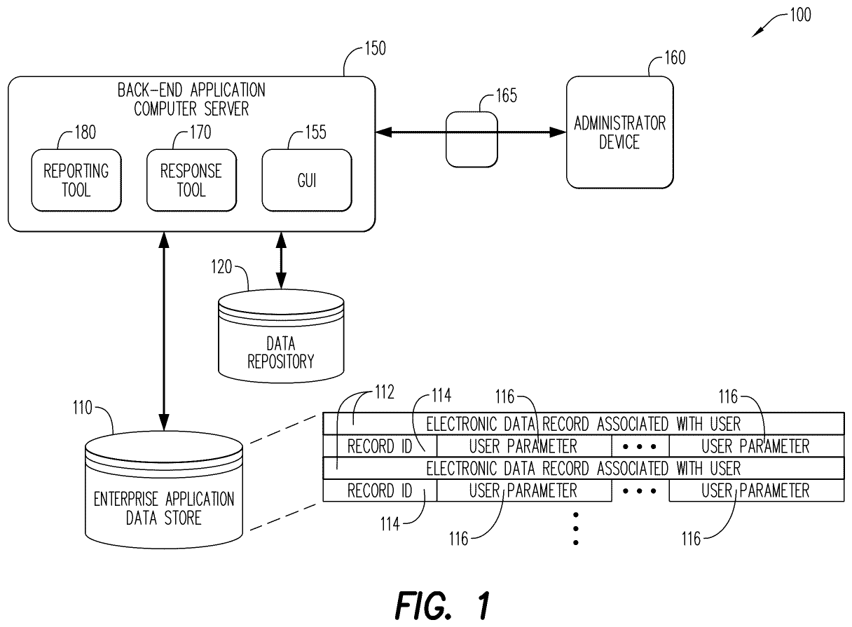

FIG. 1 is a high-level block diagram of an SQL generation framework or system 100 according to some embodiments of the present invention. In particular, the system 100 includes a back-end application computer server 150 that may access information in an enterprise application data store 110 (e.g., storing a set of electronic records associated with a set of users 112, each record including, for example, one or more record identifiers 114, user parameters 116 such as name, date of birth, claim status, etc.). The back-end application computer server 150 may also exchange information with other data stores (e.g., a data repository 120) and utilize a Graphical User Interface (“GUI”) 155 to view, analyze, and/or update the electronic records. The back-end application computer server 150 may also exchange information with a remote administrator device 160 (e.g., via a firewall 165). In some embodiments, the remote administrator device 160 may transmit annotated and/or updated information to the back-end application computer server 150. Based on the updated information, the back-end application computer server 150 may adjust data in the enterprise application data store 110, the data repository 120, and/or the change may be viewable via other remote administrator devices. Note that the back-end application computer server 150 and/or any of the other devices and methods described herein might be associated with a third party, such as a vendor that performs a service for an enterprise.

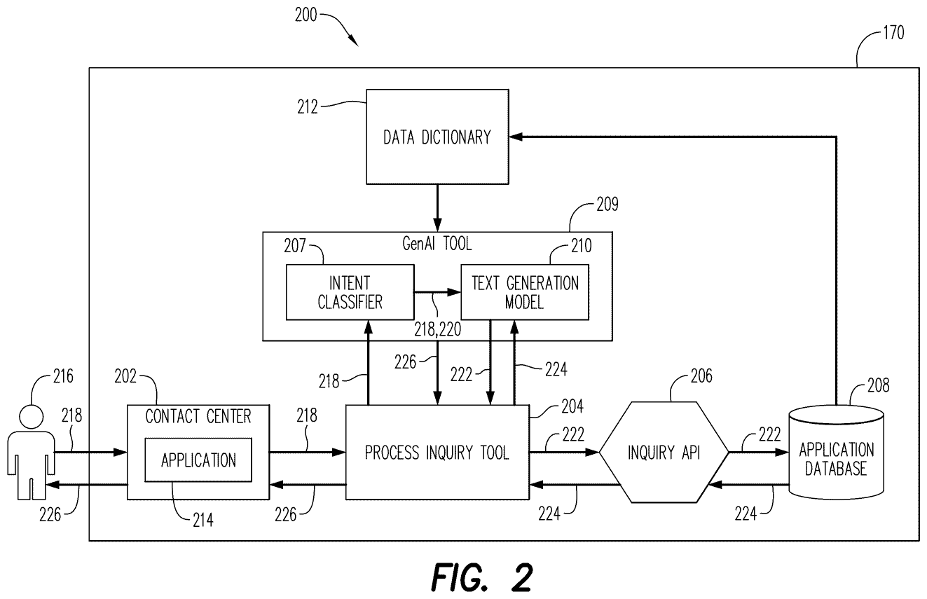

The back-end application computer server 150 may also include a response tool 170 that may access information in the enterprise application data store 110 and/or data repository and generate a response to a query, as described further below with respect to FIG. 2.

The back-end application computer server 150 and/or the other elements of the system 100 might be, for example, associated with a Personal Computer (“PC”), laptop computer, smartphone, an enterprise server, a server farm, and/or a database or similar storage devices. According to some embodiments, an “automated” back-end application computer server 150 (and/or other elements of the system 100) may facilitate the automated access and/or update of electronic records. As used herein, the term “automated” may refer to, for example, actions that can be performed with little (or no) intervention by a human.

As used herein, devices, including those associated with the back-end application computer server 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the enterprise application data store 110 and the data repository 120. The enterprise application data store 110 and data repository 120 may be locally stored or reside remote from the back-end application computer server 150. As will be described further below, the enterprise application data store 110 may be used by the back-end application computer server 150 in connection with the response tool to access and update electronic records. Although a single back-end application computer server 150 is shown in FIG. 1, any number of such devices may be included. Moreover, various devices described herein might be combined according to embodiments of the present invention. For example, in some embodiments, the back-end application computer server 150 and enterprise application data store 110 might be co-located and/or may comprise a single apparatus and/or be implemented via a cloud-based computing environment.

The back-end application computer server 150 may also include a reporting tool 180. The reporting tool 180 may be used to capture different metrics. As a non-exhaustive example, the reporting tool 180 may indicate the number of times a call was diverted to a human because the system could not generate an answer. The reporting tool 180 may also indicate if people are asking the same question differently and the effect of that different phrasing. Pursuant to some embodiments, the reporting tool 180 may also capture associations between different questions. As a non-exhaustive example, 80% of people who call to find out when a payment is due also ask about their eligible benefits. Based on this, the system may pro-actively provide eligible benefits when the query relates to payment due dates.

Turning to FIG. 2, a block diagram of an architecture 200 of the response tool 170 is provided according to some embodiments.

The response tool 170 may include a contact center 202, a process inquiry tool 204, an inquiry API 206, an application database 208, a Gen AI tool 209 (including an intent classifier 207 and a text generation model (e.g., LLM) 210) and a data dictionary 212. It is noted that while a single application database, text generation model and data dictionary are shown herein for case of explanation, embodiments may include more than one application database, text generation model and data dictionary. It is further noted that a data dictionary may be created for each respective application.

The contact center 202 may include an application 214. The application 214 may comprise program code executable by an application platform (e.g., a runtime environment) to cause actions described herein. In some examples, a user 216 accesses the application 214 to submit a user query thereto. The user 216 may access the application 214 via a user interface of the application 214 (e.g., directly or via a chatbot), via a voice inquiry to an IVR system, via an artificial intelligence (AI) application, e.g., Alexa®, or via any other suitable access tool. The user 216 may interact with a user interface (e.g., using a keyboard and/or pointing device of a user interface system) to input a natural language query 218 (e.g., “What is the status of my claim?”) for submission. According to some embodiments, the user 216 speaks a natural language query, which is detected by a microphone, converted to text by speech-to-text component and may be used to populate a user interface.

In response to the user query, the application 214 at the contact center 202 determines the presence of the user query and transmits the user query 218 to the process inquiry tool 204. The process inquiry tool 204 may perform authorization, syntax and/or logical checks on the user query prior to transmission to the GenAI tool 209. The process inquiry tool 204 loads the user query into flexible database tables (“flex tables”). Flex tables are database tables designed for loading and querying unstructured data. Flex tables may contain only unstructured, raw data, or both unstructured and columnar data. In some embodiments the process inquiry tool 204 loads the user query into structured (e.g., non-flexible) database tables.

The intent classifier 207 of the GenAI tool 209 applies machine learning and natural language processing to the user query 218 to identify/extract and output one or more intents 220 of the query. As used herein, “intents” are ways of categorizing meanings for a string of words. The “intent” is the identification and categorization of what a user intended or wanted to find when they entered their query. The intent classifier 207 extracts the one or more intents 220 based on action verbs in the natural language query. The intent classifier 207 may extract the one or more intents based on other parameters besides, or in addition to, action verbs. As a non-exhaustive example, the claim system may have 100 tables and the query is about payments. The GenAI tool 209 then identifies the payment table as the data source for the SQL query.

In some embodiments, the intent classifier 207 is an LLM-based intent classifier that uses LLMs to classify intents. The LLM-based intent classifier may rely on a method called retrieval augmented generation (RAG), which combines the benefits of retrieval-based and generation-based approaches, as described further below.

The text generation model 210 receives the extracted intents 220 and the user query 218 from the intent classifier 207. Execution of the trained text generation model outputs a Structured Query Language (SQL) query 222. The text generation model 210 is a trained model and may comprise a neural network trained to generate a SQL query based on input text. SQL is a standard language for storing, manipulating and retrieving data in databases. SQL allows users to query, retrieve, and analyze data stored in tables and columns. A SQL query is a query written in SQL format. The SQL query includes SQL statements, consisting of standard keywords/commands. The standard commands include, but are not limited to, Select, Update, Delete, Insert Into, Create Database, Create Table, Alter Database, etc. For example, a SQL statement that returns all records from a table named “Customers” is: “SELECT*FROM Customers”.

Trained text generation model 210 may be implemented by a set of linear equations, executable program code, a set of hyperparameters defining a model structure and a set of corresponding weights, or any other representation of an input-to-output mapping which was learned as a result of the training.

According to some embodiments, the trained text generation model 210 is a large language model (LLM) conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights, as well as the functions that compute the internal states, are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between tokens. Attention layers may employe self-attention mechanisms which are capable of considering different parts of input text and/or the entire context of the input text to generate output text.

Non-exhaustive examples of trained text generation model 210 include GPT, LaMDA, Claude or the like. The trained text generation model 210 may be publicly available or deployed within a landscape which is trusted by a provider of the system 100. Similarly, text generation model 210 may be trained based on public and/or private data.

In one or more embodiments, the trained text generation model 210 may be trained with a data dictionary 212. The data dictionary 212 is a collection of metadata for each item such as object name, description and/or definition, data type, size, classification, and relationships with other data sets. The data dictionary 212 may include a data structure including, but not limited to, tables, entities, fields, etc. for a given application. Pursuant to embodiments, the data dictionary 212 may be application-specific and generated for each application with data from an application-specific database (e.g., application database 208). Since the data dictionary 212 is used by the GenAI tool 209 to convert the natural language query to a SQL query, during creation of the data dictionary 212, the descriptions/context are created using multiple details in the field descriptions to help train the text generation model 210 to answer the queries. The multiple details in the description provide for the generation of a same SQL query for different natural language queries, for example. As a non-exhaustive example, the same SQL query may be generated for both natural language queries: 1. “How many users have logged-in in the last 30 days,” and 2. “How many users are active in the last 30 days,” by having the description for the last log-in date field as “last log-in activity date”. The inventors note that training the text generation model 210 with an application-specific data dictionary makes the model more robust as the model is aware of the specific schema (e.g., collection of tables for the application), data, verbiage, available SQL scripts for the schema, etc. Pursuant to some embodiments, prompt engineering and Retrieval Augmented Generation (RAG) may be used to fine-tune the text generation model 210 to improve the quality of the results output by the model. With prompt engineering, a prompt contains information like the instruction or question being passed to the model and includes other details such as context, input or examples. The prompt instructs the model to perform a desired task. With RAG, an information retrieval component is combined with a text generator model. RAG takes an input and retrieves a set of relevant/supporting documents given a source (e.g., updated application documents). The documents are concatenated as context with the original input prompt and fed to the text generator which produces the final output. Pursuant to other embodiments, the text generation model 210 may be fine-tuned by adjusting some of the weights of the model from a model weight matrix.

The inquiry API 206 is a no contract API, and instead is an open query and response-based API. The process inquiry tool 204 receives the query 222 output by the text generation model 210 and invokes the inquiry API 206 with the query. The inquiry API 206 may be written in Python®, JAVA® or any other suitable language. The inquiry API 206 is an API that accesses the requested-for data. The query 222 that is output by the text generation model 210 includes an endpoint (e.g., data source from which data is retrieved for responding to the query). The inquiry API 206 uses the endpoint and runs the query against the data source (e.g., database) indicated in the query. The inquiry API 206 may require the appropriate authorization (e.g., security using rules/rules, password, basic authentication, API kyes, OAuth, etc.) from the user prior to running the query against the database. Pursuant to some embodiments, the authorization may be provided by the process inquiry tool 204. In response to execution of the query, the inquiry API 206 receives a structured result set 224.

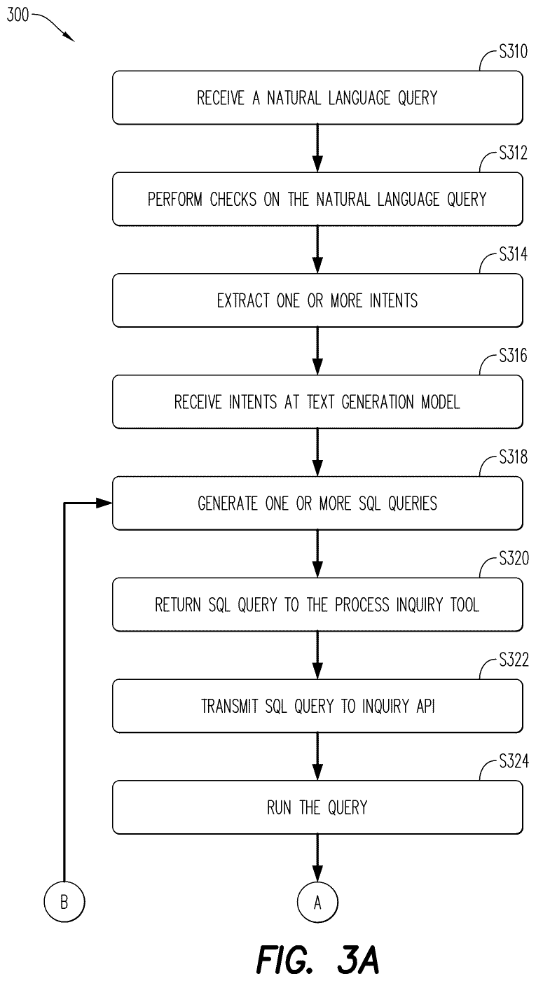

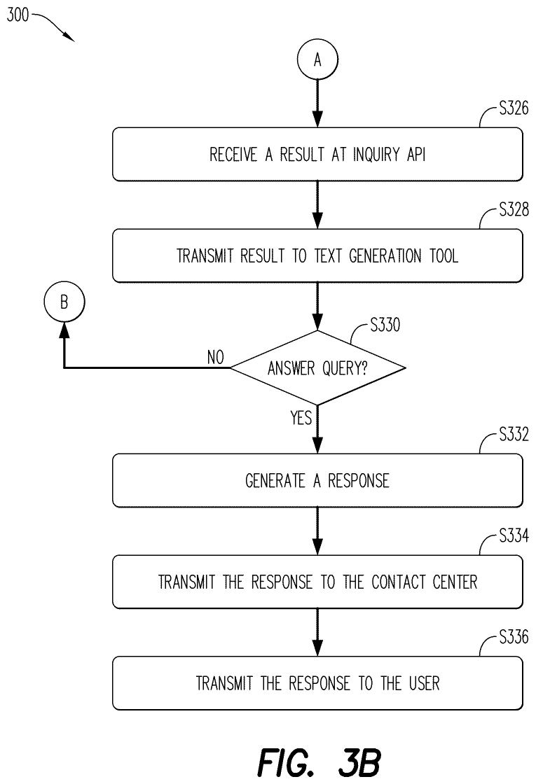

Note that the system 100 of FIG. 1 is provided only as an example, and embodiments may be associated with additional elements or components. FIGS. 3A and 3B illustrate a process 300 that might be performed by some or all of the elements of the system 100 described with respect to FIGS. 1 and 2, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

FIGS. 3A and 3B comprise a flow diagram of a process 300 to generate an answer to a user query by executing the response tool 170 according to some embodiments. Process 300 and other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any one or more processing units, including but not limited to a processor, a processor core, and a processor thread. Embodiments are not limited to the examples described below.

Prior to the process 300, a data dictionary 212 is generated for an application based on the application-specific database 208, and the text generation model 210 is trained using the data dictionary.

Initially at S310 a natural language query 218 is received. The natural language query 218 is received by the contact center 202 via an application 214. The natural language query 218 may be received via typing, speech (e.g., a phone call, etc.). The natural language query may be received by a user interface (UI) system comprising a user device including, but not limited to, a laptop computer, a desktop computer, a smartphone, a tablet computer, a touch-tone phone, etc. The natural language query may be created by a user in any suitable manner. A user may, for example, input the natural language query into an application UI and instruct the application to answer the query or may interact with an IVR system to input the natural language query and instruct the application to answer the query. Responsive to the received instruction, the application 214 at the contact center 202 determines the presence of the user query and transmits the user query to the process inquiry tool 204.

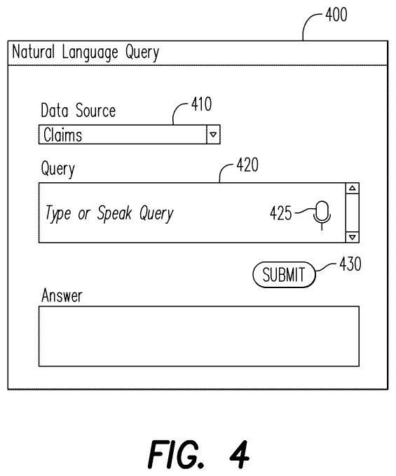

FIG. 4 illustrates user interface 400 of an application according to some embodiments. In one example, user 216 executes a Web browser to access the contact center 202 via HTTP and to receive user interface 400 in return. User interface 400 includes drop-down field 410 for selecting a data source to be queried. User selection of a data source is not required according to some embodiments, for example, because the user is uncertain of the data source, the query is via speech and requiring selection of a data source is too difficult, more than one data source may be required to generate a response, etc.

Area 420 receives the natural language query, via typing, for example. In this non-exhaustive example, the query is: “What is my claim status?” Pursuant to some embodiments, the system 100 may include a speech-to-text functionality whereby area 420 is populated using speech. In some instances, the speech-to-text functionality is activated via selection of an icon 425. In other instances, the speech-to-text functionality is activated by speaking (e.g., in a case of a call received via phone). A Submit control 430 is selected to transmit the query to the process inquiry tool 204 and to cause process 300 to proceed to S312. While the submit control 430 is shown herein as causing the process 300 to proceed to S312, it is noted that the process 300 may proceed to S312 in response to another type of submission (e.g., a particular spoken word, a particular key stroke, etc.).

At S312, the process inquiry tool 204 performs authorization and authentication checks (e.g., the user may provide certain credentials in order to log on to the application and receive an answer to the query). In some embodiments, a token may be provided to the user 216, for example, in response to acceptance of the credentials. Prior to transmitting the query to the endpoint (e.g., application database 208), the token may be passed to the contact center 202 and then to the process inquiry tool 204 with the query and used to access the endpoint. The process inquiry tool 204 may also perform syntax and/or logical checks on the natural language query. As a non-exhaustive example, the syntax and logical checks may include checks of grammar, word arrangement, and the identification of relationships between words and whether those make sense.

Then at S314, the Gen AI tool 209 receives the natural language query 218 and the intent classifier 207 extracts one or more intents 220 from the natural language query 218. The intent classifier 207 applies machine learning and natural language processing to the natural language query to identify/extract and output one or more intents 220 of the query. Pursuant to embodiments, the GenAI tool 209 is able to discern languages and accents to identify appropriate intents and translate the natural language into a SQL query and back to the appropriate language. As described above, the intent classifier 207 extracts the one or more intents based on action verbs in the natural language query. Continuing with the non-exhaustive example query of “What is my claim status?”, this query includes two intents: 1. Claim number, and 2. Status.

The intent classifier 207 transmits the one or more intents 220 and the natural language query 218 to the text generation model 210 in S316. The text generation model 210 generates one or more SQL queries 222 based on the one or more intents 220 and natural language query 218 in S318. As described above, the text generation model 210 is trained with an application-specific data dictionary 212 so that the text generation model 210 generates SQL queries with appropriate data sources and fields to retrieve the desired data.

Then in S320, the SQL query 222 is returned to the process inquiry tool 204, and the process inquiry tool 204 transmits the SQL query 222 and the authentication and authorization to the inquiry API 206 in S322. The inquiry API 206 determines the endpoint/data source identifier (e.g., application database 208) and an API call (e.g., the specific request to access particular data) from data included in the SQL query 222 and invokes the API call so that the query is run against the appropriate database in S324. The inquiry API 206 receives a structured result 224 from the application database 208 in S326 and transmits the structured result 224 to the text generation model 210 via the process inquiry tool 204 in S328. The text generation model 210 may determine whether it is able to answer the natural language query using this structured result 224 in S330 and, if so, returns a result by continuing the flow to S332, as described further below. If not, the text generation model 210 may generate another SQL query or update a SQL query, as needed, per S318. Flow may continue to cycle to transmit SQL queries to various endpoints until it is determined at S330 that the text generation model 210 has received information to answer the natural language query.

Continuing with the non-exhaustive example, for the first intent, to return the claim number from a Customer table, the SQL query may be:
SELECT ClaimNumber FROM Customer WHERE Name=‘JoeSmith’.

Here, the inquiry API 206 receives the result “12345” and returns the result to the text generation model 210. The text generation model 210 then determines it is unable to answer the natural language query “What is my claim status” using only claim number “12345”. In some instances, the text generation model 210 may have initially generated two SQL queries—one for each intent—for this example and updates the SQL query for the second intent with the claim number. In other instances, the text generation model 210 generates a SQL query for the second intent after it receives the claim number. It is noted that while in the non-exhaustive example herein separate SQL queries are generated for each intent, in some embodiments a single SQL query is generated for multiple intents.

For the second intent, to return the status from a Claims table, the SQL query may be:
SELECT Status FROM Claims WHERE ClaimNumber=12345.

It is also noted that while in this non-exhaustive example, the name was used to retrieve the claim number and then the claim number was used to retrieve the status, in other non-exhaustive examples, the name alone (or phone number or other customer information) may be used to retrieve the claim status. For example, if the query is through the IVF system, the phone number is on record and may be used to forward the policy number to the process inquiry tool 204.

Once it is determined the query is answered in S330, the process 300 proceeds to S332 and the GenAI tool 209 generates a response 226 based on the result 224 and the intents 220. For example, the result 224 may be the claim number “12345” or the term “open” and the GenAI tool 209 converts that to “the claim status is open,” which is transmitted to the user. The response 226 may be a natural language response and may be a text response or a voice response. The response 226 may be a wave file, mp4 file or any other suitable file. Pursuant to embodiments, the text generation model 210 may be used to generate the text response and a text-to-speech functionality may transform the text response into a speech/voice response. The GenAI tool 209 transmits the response 226 to the process inquiry tool 204 and the process inquiry tool 204 transmits the response 226 to the contact center 202 in S334. In S336, the contact center 202 transmits the response 226 to the user 216.

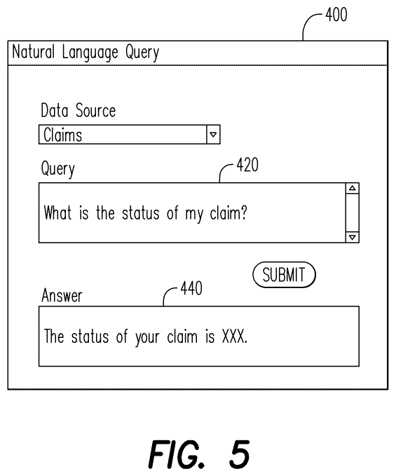

FIG. 5 shows interface 400 of FIG. 4 with an answer to the user query of area 420 presented in area 440. Embodiments may thereby allow a typical end-user to efficiently receive desired information from a data source.

It is noted that the user may input a second query based on the response 226. Continuing with the non-exhaustive example described herein, if a claim status is denied, the user may want to know why it was denied. The response may include a reason related to relative benefits.

In a case the process inquiry tool 204 does not receive a response 226 (e.g., the SQL query could not be generated, the SQL query failed to return a result, etc.), the process inquiry tool 204 sends an instruction to the call center to redirect the inquiry to a customer service resource center for additional assistance (e.g., from a human), or the process inquiry tool 204 may, in a case of a chat interface, ask the user for additional information. Pursuant to embodiments, in a case the process inquiry tool 204 does not find an answer, the data associated with the lack of answer may be used to fine tune the models. Further, reporting tool 180 may summarize the information (e.g., how many people asked this kind of intent query against the claims status), determine categories of intent, why the query failed, etc., and use this information to further train the model.

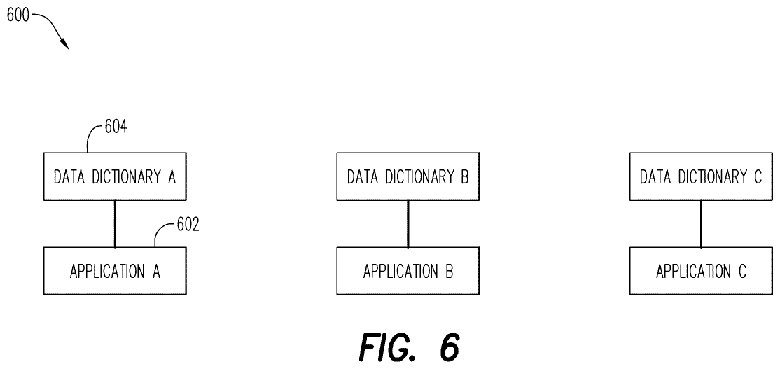

FIG. 6 shows a block diagram 600 of each application 602 having a respective data dictionary 604 mapped thereto. As described above, the data dictionary may be application-specific and generated for each application with data from an application-specific database (e.g., application database 208). The data dictionary is used to train the text generation model 210, and the use of an application-specific data dictionary makes the model more robust as the model is aware of the specific schema (e.g., collection of tables for the application), data, verbiage, available SQL scripts for the schema, etc.

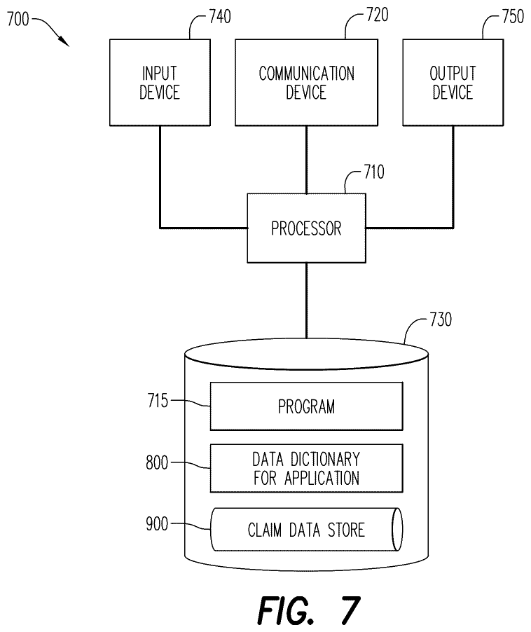

The embodiments described herein may be implemented using any number of different hardware configurations. For example, FIG. 7 illustrates an apparatus 700 that may be, for example, associated with system 100 described with respect to FIG. 1. The apparatus 700 comprises a processor 710, such as one or more commercially available Central Processing Units (“CPUs”) in the form of one-chip microprocessors, coupled to a communication device 720 configured to communicate via a communication network (not shown in FIG. 7). The communication device 720 may be used to communicate, for example, with one or more remote third-party business or economic platforms, administrator computers, insurance agent, and/or communication devices (e.g., PCs and smartphones). Note that communications exchanged via the communication device 720 may utilize security features, such as those between a public internet user and an internal network of an insurance company and/or enterprise. The security features might be associated with, for example, web servers, firewalls, and/or PCI infrastructure. The apparatus 700 further includes an input device 740 (e.g., a mouse and/or keyboard to enter information about data sources, natural language queries, third-parties, etc.) and an output device 750 (e.g., to output reports regarding natural language queries, answers to natural language queries, recommendations, alerts, etc.).

The processor 710 also communicates with a storage device 730. The storage device 730 may comprise any appropriate information storage device, including combinations of magnetic storage devices (e.g., a hard disk drive), optical storage devices, mobile telephones, and/or semiconductor memory devices. The storage device 730 stores a program 715 and/or an application for controlling the processor 710. The processor 710 performs instructions of the program 715, and thereby operates in accordance with any of the embodiments described herein. For example, the processor 710 may receive a natural language query input and, based on the system tools, automatically retrieves a response and outputs the response to the user.

The program 715 may be stored in a compressed, uncompiled and/or encrypted format. The program 715 may furthermore include other program elements, such as an operating system, a database management system, and/or device drivers used by the processor 710 to interface with peripheral devices.

As used herein, information may be “received” by or “transmitted” to, for example: (i) the apparatus 700 from another device; or (ii) a software application or module within the apparatus 700 from another software application, module, or any other source.

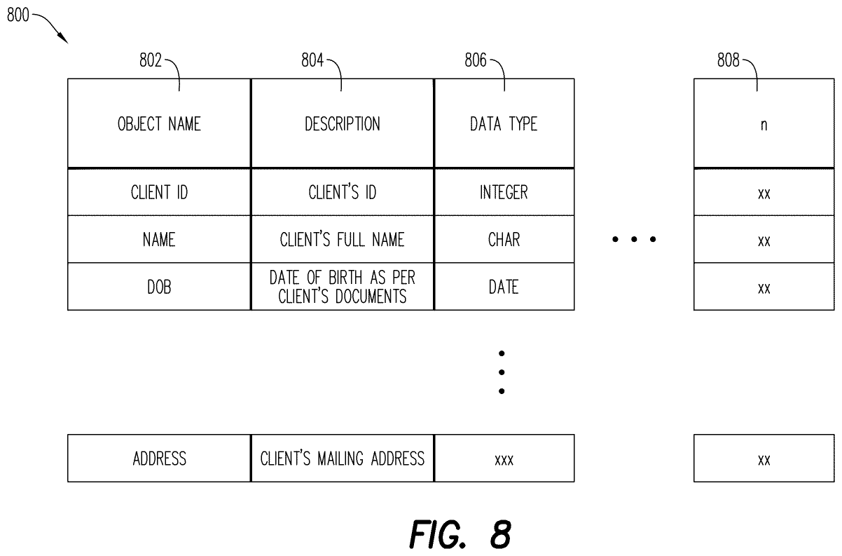

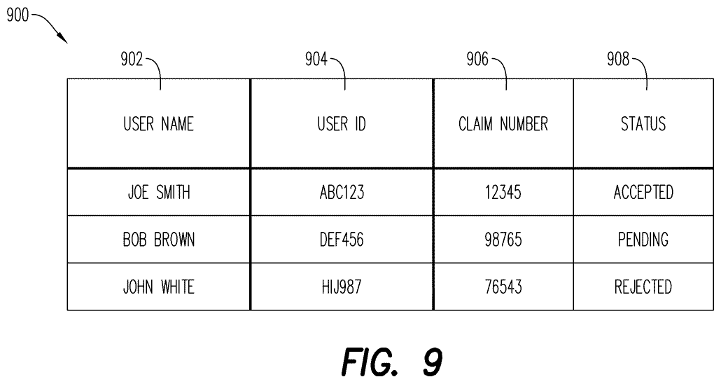

In some embodiments (such as shown in FIG. 7), the storage device 730 further includes a data dictionary data store for a customer application 800 and a claims data store 900. Examples of databases that might be used in connection with apparatus 700 will now be described in detail with respect to FIGS. 8 and 9. Note that the databases described herein are only examples, and additional and/or different information may be stored therein. Moreover, various databases might be split or combined in accordance with any of the embodiments described herein. For example, the data dictionary data store for the customer application 800 and the claims data store 900 might be combined and/or linked to each other within the program 715.

Referring to FIG. 8, a table is shown that represents the data dictionary data store for a customer application 800 that may be stored at the apparatus 700 according to some embodiments. The table may include, for example, entries associated with a customer application. The table may also define fields 802, 804, 806 and 808 for each of the entries. The fields 802, 804, 806 and 808 may, according to some embodiments, specify: an object name 802, a description 804, a data type 806, and additional fields (n) 808. The data dictionary data store for the customer application 800 may be created and updated, for example, based on information received from sources associated with the applications used by the enterprise.

The object name 802 may comprise the name of the object that may be called by the GenAI tool 209. The description 804 may reflect the terms used to describe the object. The data type may describe the type of data supported by the object (e.g., integer, character, numeral, date etc.).

Referring to FIG. 900, a table is shown that represents the claims at an enterprise that may be stored at the apparatus 700 according to some embodiments. As a non-exhaustive example, the enterprise is an insurance company and the claims are short term disability claims. The table may include, for example, entries associated with users that may be used to identify their claim status. The table may also define fields 902, 904, 906 and 908 for each of the entries. The fields 902, 904, 906 and 908 may, according to some embodiments, specify: a user name 902, a user ID 904, a claim number 906 and a status 908. The user name 902 may be, for example, the name of the claimant. The user ID 904 may be, for example, a unique alphanumeric code identifying the user (e.g., social security number). The claim number 906 may be, for example, a unique alphanumeric code identifying the claim for that user. The claim status 908 may be used for example, to indicate the status of the claim for that user.

Thus, embodiments may provide a SQL generation framework 100 that can respond to a query without building an API for each query, or building an API for each new table because the generated SQL query retrieves the appropriate data. Embodiments provide for accessing databases without knowing a context/configuration details for a specific API which saves computing resources and time. Embodiments also provide for pro-actively providing information to a user based on previous requests from other users, thereby reducing used messaging bandwidth involved in the back and forth between users and the system.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of entities, embodiments may instead be associated with other types of businesses in addition to and/or instead of those described herein. Similarly, although certain types of insurance, business operation, and entity parameters were described in connection with some embodiments herein, other types of insurance products and/or entity parameters might be used instead.

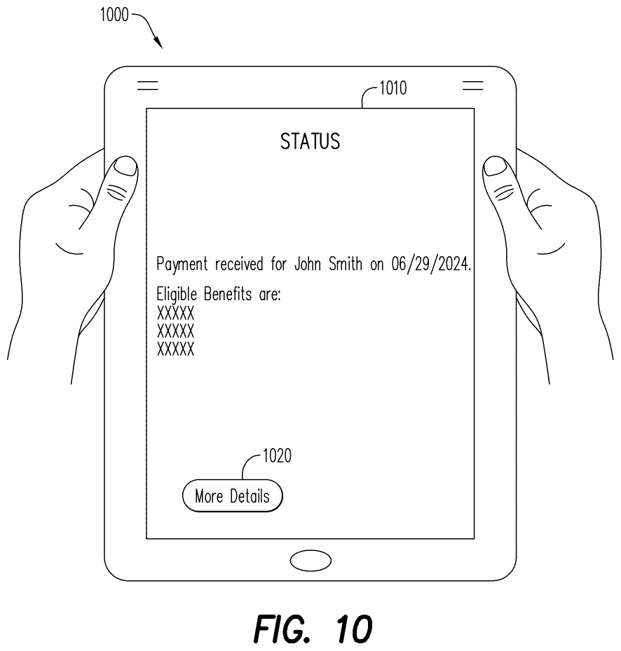

Note that the displays and devices illustrated herein are only provided as examples, and embodiments may be associated with any other types of user interfaces. For example, FIG. 10 illustrates a handheld tablet computer 1000 with a claim status display 1010 according to some embodiments. The claim status display 1010 shows elements that may be utilized by a user of the tablet computer 1000 (e.g., via “More Details” icon 1020) to receive more details about the claim and/or claim status (e.g., “Jane is your claim handler, and for any questions, please contact Jane via jane@enterprise.com or 888-888-8888”). According to some embodiments, the display 1010 also includes an indication of other benefits the user is eligible for.

The present invention has been described in terms of several embodiments solely for the purpose of illustration. Persons skilled in the art will recognize from this description that the invention is not limited to the embodiments described but may be practiced with modifications and alterations limited only by the spirit and score of the appended claims.

1. A system comprising:
a memory storing program code: and
one or more processing units to execute the program code to cause the system to:
receive a natural language query;
generate a Structured Query Language (SQL) query based on the received natural language query;
determine, via a no contract-based Application Programming Interface (API), an endpoint and an API call from data included in the generated SQL query;
invoke the no contract-based API;
receive a response to the SQL query from a data source via the no contract-based API;
generate a natural language response from the response to the SQL query; and
transmit the natural language response to an entity.

2. The system of claim 1, further comprising program code to cause the system to:
extract one or more intents from the natural language query; and
transmit the extracted one or more intents to a text generation tool for generation of the SQL query.

3. The system of claim 2 wherein the one or more intents are extracted based on action verbs in the natural language query.

4. The system of claim 2, wherein the text generation tool is a large language model (LLM).

5. The system of claim 4, wherein the LLM is trained with one or more data dictionaries.

6. The system of claim 5, wherein each data dictionary is generated for a respective application-specific database.

7. The system of claim 1, wherein the SQL query includes a data source identifier.

8. The system of claim 1, wherein the API call provides security to the data source.

9. A method comprising:
receiving a natural language query;
extracting one or more intents from the natural language query;
generating a Structured Query Language (SQL) query based on the extracted intents;
determining, via a no contract-based Application Programming Interface (API), an endpoint and an API call from data included in the generated SQL query;
invoking the no contract-based API;
receiving a response to the SQL query from a data source via the no contract-based API;
generating a natural language response from the response to the SQL query; and
transmitting the natural language response to an entity.

10. The method of claim 9, wherein a large language model (LLM) generates the SQL query.

11. The method of claim 10, wherein the LLM is trained with one or more data dictionaries.

12. The method of claim 11, wherein each data dictionary is generated for a respective application-specific database.

13. The method of claim 9, wherein the SQL query includes a data source identifier.

14. The method of claim 9, wherein the natural language response is transmitted as a text response or a voice response.

15. One or more non-transitory computer-readable media storing program code that, when executed by a computing system, causes the computing system to perform operations comprising:
receiving a natural language query;
extracting one or more intents from the natural language query;
generating a Structured Query Language (SQL) query based on the extracted intents;
determining, via a no contract-based Application Programming Interface (API), an endpoint and an API call from the extracted one or more intents;
invoking the no contract-based;
receiving a response to the SQL query from a data source via the no contract-based API;
generating a natural language response from the response to the SQL query; and
transmitting the natural language response to an entity.

16. The media of claim 15, wherein the one or more intents are extracted based on action verbs in the natural language query.

17. The media of claim 15, wherein a large language model (LLM) generates the SQL query.

18. The media of claim 17, wherein the LLM is trained with one or more data dictionaries.

19. The media of claim 18, wherein each data dictionary is generated for a respective application-specific database.

20. The media of claim 15, wherein the natural language response is transmitted as a text response or a voice response.
